(19) United States
(12) Patent Application Publication
(10) Pub. No.: US 2024/0065145 A1
(43) Pub. Date: Feb. 29, 2024

(54) Mower Knife Device

(71) Applicant: Wepfer Technics AG, Andelfingen (CH)

(72) Inventor: Hans WEPFER, Berg-Dägerlen (CH)

(73) Assignee: Wepfer Technics AG, Andelfingen (CH)

(21) Appl. No.: 18/266,172

(22) PCT Filed: Oct. 28, 2021
(86) PCT No.: PCT/EP2021/080041

§ 371 Date: Jun. 8, 2023

(30) Foreign Application Priority Data
Oct. 29, 2020 (EP) 20204705.6
Oct. 29, 2020 (EP) 20204706.4

(51) Int. Cl. A01D 34/135; A01D 34/17

(52) U.S. Cl. CPC A01D 34/135; A01D 34/17

(57) ABSTRACT

The present disclosure relates to a mower knife device with a knife bar and a dual blade cutting system. The dual blade cutting system includes an upper cutting knife and a lower cutting knife designed to be movable relative to one another. The upper cutting knife is connected to the knife bar by means of an upper retaining device. The lower cutting knife is connected to the knife bar by means of a lower retaining device. The upper retaining device is mounted on the knife bar by means of a guide bushing. A preloaded tension spring is arranged inside the guide bushing. The tensile force of the tension spring is designed to apply a contact pressure of the upper cutting knife to the lower cutting knife via the upper retaining device.

### CROSS REFERENCE TO RELATED APPLICATIONS

This application is a national phase application of International Application No. PCT/EP2021/080041, filed Oct. 28, 2021, which claims priority to two European Patent Applications EP 20 204 706.4 and EP 20 204 405.6, both filed on Oct. 29, 2020, the content of all of the aforementioned of which is herein incorporated by reference.

### BACKGROUND OF THE INVENTION

### Field of the Invention

The invention relates to a mower knife device with a knife bar and a dual knife cutting system, wherein the dual knife cutting system comprises an upper cutting knife and a lower cutting knife, which are designed to be movable relative to one another, wherein the upper cutting knife is designed to be connected to the knife bar by means of an upper retaining device and the lower cutting knife is designed to be connected to the knife bar by means of a lower retaining device.

Mower knife devices are well known in the prior art. Mower knife devices are also called cutting units and are used in particular in mowing machines, such as combine harvesters or mower tractors. Preferably, such mower knife devices comprise two knife rails lying one on top of the other and movable back and forth against each other, each of which has a plurality of blade elements. In order to reduce the wear of the cutting knives, it is on the one hand advantageous to press the two knife rails lying one on top of the other against each other, so that as far as possible no impurities such as stones or the like can get between the knife rails. On the other hand, the pressure between the knife rails lying on top of each other should not be too great, so that the knife rails do not wear each other out too much.

### Description of Related Art

For example, a mower knife press-on device with a lower part to be placed against a finger bar and a swiveling upper part placed on the finger bar is known from DE2711352A1. The swivel axis is arranged parallel to the knife press-on part of the downwardly bent upper part. In an area of the upper part facing away from the knife press-on part, there is at least one compression screw for adjusting the contact pressure of the knife press-on part, and the swivel axis is closer to the rear edge than to the knife press-on part. This makes it possible to create a mower knife press-on device that has a low overall height and can be easily adapted to differently shaped finger bars and knives of different heights and wear. It is also easy to clean and inexpensive to manufacture.

DE598983A discloses a cutting unit with two guide beams. Tension-adjustable springs are arranged between the guide beams. The upper knife rail and its knives are thus not only relieved of the weight of their guide beam, but can also be readjusted with the guide beam at any time according to wear. The upper knives are attached to the rectangular rail, which engages in a groove of the guide beam. The lower knives are attached to a rectangular rail, which is guided in a groove of the lower guide beam. The two knife rails are moved back and forth with the rows of knives attached to them in a known manner in opposite directions. At the rear edge, the guide rods are connected in a known manner by a number of joints, so that the upper guide rod can be folded open for cleaning the cutting unit and for removing the knife bars with the knives. Behind the knife rails, the beams are each provided with a recess on the sides facing each other, in which a compression spring or other elastic body is inserted between the two beams. The springs tend to lift the upper guide beam from the lower guide beam. The weight of the upper guide beam is therefore approximately balanced by the springs.

A disadvantage in the prior art is that the wear of the known mower knife devices and the resulting maintenance costs are very high.

### BRIEF SUMMARY OF THE INVENTION

It is an object of the invention to create a mower knife device belonging to the technical field mentioned at the beginning, which at least partially overcomes the disadvantages from the prior art and proposes an improved concept for a mower knife device.

A first solution to the object of the invention is defined by the features of claim 1. According to the invention, the mower knife device comprises a knife bar and a dual knife cutting system, the dual knife cutting system comprising an upper cutting knife and a lower cutting knife, which are designed to be movable relative to one another, the upper cutting knife being connected to the knife bar by means of an upper retaining device and the lower cutting knife being connected to the knife bar by means of a lower retaining device. The upper retaining device is mounted on the knife bar by means of a guide bushing and a preloaded tension spring is arranged inside the guide bushing. The tensile force of the tension spring is designed to apply a contact pressure of the upper cutting knife to the lower cutting knife via the upper retaining device.

The subject matter of the invention achieves, for example, the technical advantage that the tension spring is subjected exclusively to tensile stress. As a result, the contact force of the upper cutting knife on the lower cutting knife is not generated by a tilting movement of the retaining device, but is transmitted by a pure tensile movement of the retaining device, with the effective direction of the contact force being parallel to the longitudinal direction of the guide bushing. This significantly reduces wear on the cutting knives, since the contact force is evenly distributed. In addition, this has the advantage that it is possible to change the cutting knife with less effort, since disassembly of the retaining device generates only little effort.

Another significant advantage of the device according to the invention is caused by the mechanical load on the mower knives during operation. Frequently, the upper cutting knife is pushed upwards by stones or is severely deformed by impurities between the upper cutting knife and the lower cutting knife. These deformations put additional stress on the cutting knives and increase wear. Due to the spring mounted in the guide bushing, the retaining device can yield to the contact force in the opposite direction, whereby the impurities are removed autonomously and cannot cause permanent wear on the cutting knives. This extends the service life of the mower knife device, as wear is reduced additionally.

According to a preferred embodiment, the guide bushing is held in a threaded bushing. This has the technical advantage, for example, that the guide bushing can be arranged in such a way that it is protected against contamination and a suitable force can be transmitted from the retaining device via the guide bushing to the threaded bushing.

According to another embodiment, the threaded bushing can be screwed to the knife bar via an external thread. This has the additional advantage that the threaded bushing ensures reliable force transmission into the knife bar. Furthermore, it is possible to dismantle or replace the threaded bushing without increased assembly effort. In addition, the thread can be used to change the absolute position of the threaded bushing relative to the knife bar. This can be advantageous, for example, after a cutting kife change for precise adjustment of the mower knife device.

To further reduce wear during operation of the mower knife device and to increase the service life of the device according to the invention, the guide bushing is held in the threaded bushing via a bearing. The bearing may include, for example, two different bearing functions that occur during operation of the mower knife device. On the one hand, this relates to a rotational component which is generated due to the movement of the upper and lower cutting knives relative to each other. This rotational load can be accommodated, for example, by using an annular roller bearing. On the other hand, the bearing is also subjected to stress in the longitudinal direction of the guide bushing, which is why the arrangement of a plain bearing can be advantageous. The ideal bearing is one that can support both the rotational load and the load in the longitudinal direction of the guide bushing.

According to an advantageous embodiment, the bearing is formed on an upper side and a lower side of the threaded bushing. This takes into account an optimal bearing of the guide bushing in the threaded bushing, which additionally minimizes wear and thus increases the overall service life of the mower knife device.

According to a further advantageous embodiment, the tension spring can be tensioned by means of a spring screw. This has the technical advantage, for example, that the tension and thus the tensile force of the spring can be adjusted. In particular, the tension can be increased or reduced as required by actuating the spring screw. For example, this can be advantageous after changing the mower knives to ensure the optimum setting of the mower knife device. In addition, it is possible to vary the tension of the tension spring and thus the contact force of the upper cutting knife on the lower cutting knife for a specific application.

In order to change the contact pressure of the upper cutting knife on the lower cutting knife, the spring screw is designed to be adjustable from the outside via a bushing cover. The bushing cover is particularly easy to operate. A special tool is not absolutely necessary. For example, the bushing cover can be actuated manually or by means of a simple commercially available tool. In particular, a screwdriver, a hexagon socket screw key, a ring wrench or an open-end wrench are suitable for this purpose.

In a more advanced embodiment, the bushing cover has a radial protrusion relative to the threaded bushing. This is a particularly simple design solution. Standard components can be used for the most part, and repairs or inspections can also be carried out easily.

According to an additional embodiment, the upper retaining device has a kinking which is arranged between the guide bushing and the upper cutting knife. The kinking on the upper retaining device ensures an optimum spatial arrangement of the upper cutting knife relative to the lower cutting knife. In particular, the kinking compensates for the spatial expansion of the spring screw, which is arranged orthogonally to the knife bar due to the orientation of the guide bushing. Thus, it is not necessary for the upper retaining device to have its own elasticity. Instead, the upper retaining device can be designed as a rigid component that directly transmits the axial tensile force of the spring screw to the upper cutting knife.

According to an additional embodiment, the upper cutting knife is guided in a cutting knife bearing of the upper retaining device. The cutting knife bearing enables wear-reduced operation of the mower knife device and increases the service life of the device according to the invention.

For example, the cutting knife bearing may include two different bearing functions that occur during operation of the cutting knife device. On the one hand, this relates to a rotational component, which is generated due to the movement of the upper and lower cutting knives relative to each other. This rotational load can be accommodated, for example, by the use of an annular roller bearing. On the other hand, the cutting knife bearing is also stressed in the longitudinal direction by the contact force of the upper retaining device on the lower retaining device. In addition, the cutting knife bearing is subjected to stress by stone-chipping or clippings. The ideal bearing is one that can absorb both the rotational load and the load in the longitudinal direction.

In order to form an abutment with respect to the upper retaining device, which can absorb the contact pressure, the lower retaining device is mounted on the knife bar by means of a guide bushing. In contrast to the upper retaining device, the lower retaining device is designed to be rigid to the knife bar in the direction of the tension spring. This ensures that the upper cutting knife and the lower cutting knife can rest optimally against each other and that the contact pressure of the upper cutting knife on the lower cutting knife is ensured.

According to a preferred embodiment, the guide bushing is held in a threaded bushing. This has the technical advantage, for example, that the guide bushing can be arranged in such a way that it is protected against contamination and a suitable force can be applied from the lower retaining device via the guide bushing to the threaded bushing.

To make it as easy as possible to mount or replace the lower retaining device, the threaded bushing can be screwed to the knife bar via an external thread. This has the additional advantage that the threaded bushing ensures reliable force transmission into the knife bar. Furthermore, it is possible to dismantle or replace the threaded bushing without increased assembly effort. In addition, the thread can be used to change the absolute position of the threaded bushing relative to the knife bar. This can be advantageous, for example, after a cutting knife change for precise adjustment of the mower knife device in coordination with the upper retaining device.

According to a particularly preferred embodiment, the lower retaining device can be screwed to the knife bar by means of a screw, the screw extending completely through the guide bushing. This has the technical advantage, for example, of making it particularly easy to fix the lower retaining device to the knife bar. By passing the screw through the complete guide bushing, the force application can occur particularly symmetrical. In addition, loosening or, if necessary, changing the lower retaining device is particularly easy.

Typically, a plurality of blade elements are arranged serially along the knife bar on a cutting knife, with a lower blade element usually being associated with an upper blade element. According to a particular embodiment, the upper cutting knife comprises a plurality of blade elements, with each third upper blade element being associated with an upper retaining device. This provides, for example, the technical advantage of ensuring a continuous distribution of force to all blade elements along the knife bar. This reduces wear and additionally increases the service life of the device according to the invention.

A second solution to the object of the invention is described below. The second solution can be considered as a separate invention, existing independently from the other solutions to the object of the invention.

The second solution to the object of the invention relates to a mower knife device with a dual knife cutting system, wherein the dual knife cutting system comprises an upper cutting knife and a lower cutting knife which are designed to be movable relative to one another by means of a drive, wherein at least one of the upper cutting knife and the lower cutting knife comprises a plurality of blade elements, which are connected to one another via a knife back, and wherein the blade elements and the knife back are formed as a common integral component, and wherein the mower knife device has an exchangeable knife head for initiating a driving movement of a lateral drive onto the dual knife cutting system.

Due to the integral one-piece design of the blade elements with the knife back, interchangeability of the upper cutting knife and the lower cutting knife is significantly simplified. In addition, the one-piece design significantly reduces the mass and thickness of the upper cutting knife and the lower cutting knife. In this regard, the reduced mass allows for a reduction in wear, thereby increasing the service life of the mower knife device. The reduced thickness of the upper cutting knife and the lower cutting knife improves the sliding of clippings during operation of the mower knife device, since all edges caused by material thickening of the knife back, as caused by riveted or welded-on blade elements, are eliminated.

Another advantage is that the integral one-piece design of the blade elements improves the grinding and sharpening of the individual blade elements. Material thickening of the knife back, as caused by riveted or welded-on blade elements, makes it more difficult to access the blade elements for regular grinding and sharpening. Thus maintenance is simplified and handling improved.

An additional advantage results from the interchangeability of the knife head. For the purpose of replacing the upper cutting knife or the lower cutting knife, the knife head can be completely removed. This simplifies the work involved in changing the cutting knives. A particular advantage arises again when grinding the blade elements. Complete removal of the knife head makes it easier to access the blade elements for grinding and sharpening. This increases the service life and improves repair and handling. Furthermore, this results in cost savings.

According to a preferred embodiment, the knife head has an engaging element that is designed to engage in a corresponding engaging socket in the knife back of the upper cutting knife or the lower cutting knife. This has the technical advantage, for example, that the force application of the knife head can be carried out particularly easily in the upper cutting knife or the lower cutting knife. Thus, no additional means or components are necessary for the force introduction, whereby the overall mass and the manufacturing costs can be reduced.

According to a further embodiment, the engaging element comprises at least two engaging projections. On the one hand, this has the advantage that a very simple but fixed assignment can be realized between the knife head and the cutting knife. Additional engaging projections are conceivable, but are not absolutely necessary for the function. Therefore, the realization by means of two engaging elements is particularly efficient and simple to manufacture.

Based on this, the engaging socket of the knife back comprises engaging openings corresponding with the engaging elements. This has the particular advantage that no additional components need to be arranged between the knife back and the knife head. For example, the engaging openings can be stamped directly into the knife back. It would be conceivable to manufacture the cutting knives, including the blade elements and the knife back, as a one-piece blade made of flat steel. This flat steel allows both the blade elements and the engaging openings to be stamped out. Overall, this makes the manufacture of the mower knife device and its assembly particularly efficient.

In order to increase the service life of the mower knife device and reduce wear, the knife head has a resilient portion formed between a connecting portion of the knife head with the knife back and a terminal to the drive.

During operation of the mower knife device, the cutting knives are subjected to strong mechanical loads such as impacts or deformations, for example due to stones or other objects. A stiff, inflexible knife head as the connection between the cutting knife and the laterally attached drive places at least mechanical stress on all components of the functional chain. This additionally increases the wear of the entire mower knife device and significantly shortens its service life. The elastic section of the knife head can in particular dampen vibrations and deformations, thus relieving the load on the mower knife device. The elastic section thus increases the service life.

According to a particularly preferred embodiment, the elastic section is made of a metal. Metal has a suitable strength and at the same time can have the necessary elasticity. For example, the elastic section is made of a spring steel. Alternatively, however, it is also conceivable to manufacture the elastic section from a plastic or another suitable material.

According to a particularly preferred embodiment, the elastic section is designed to dampen a movement in a plane that is parallel to the plane defined by the blade elements of the upper cutting knife or the lower cutting knife. This achieves, for example, the technical advantage that mechanical influences, such as impacts or vibrations, which act on the cutting knives from a front side during operation, can be reduced and damped.

According to a further embodiment, the upper cutting knife is connected to a knife bar by means of an upper retaining device, the upper retaining device being mounted on the knife bar by means of a guide bushing. A preloaded tension spring is arranged inside the guide bushing for exerting a contact pressure of the upper cutting knife on the lower cutting knife.

Often the cutting knives are severely deformed by impurities, such as stones, between the upper cutting knife and the lower cutting knife. These deformations place additional stress on the cutting knives and increase wear. Due to the spring mounted in the guide bush, the retaining device can yield translationally in the opposite direction to the contact force, whereby the impurities are removed autonomously and permanent wear on the cutting knives can be reduced. This extends the service life of the cutting knife device, as wear is additionally reduced.

In other words, the spring is suitable for reducing mechanical influences, such as impacts or vibrations, which act on the cutting knives during operation and are oriented orthogonally to the plane defined by the blade elements of the upper cutting knife or the lower cutting knife.

In connection with the foregoing embodiment, the mower knife device includes damping elements configured to dampen loads in different directions and thereby reduce wear.

Specifically, the elastic section of the knife head is designed to dampen mechanical stresses that occur in a plane that is parallel to the plane defined by the blade elements of the upper cutting knife or the lower cutting knife. These mechanical influences are caused, for example, by impacts or vibrations acting on the cutting knives from a front side during operation.

In combination, the tension spring inside the guide bushing allows mechanical influences acting on the cutting knives during operation and oriented orthogonally to the plane defined by the blade elements of the upper cutting knife or the lower cutting knife to be absorbed or damped.

Thus, the mower knife device comprises an overall very low-wear solution with a long service life.

According to a preferred embodiment, the guide bushing is held in a threaded bushing. This has the technical advantage, for example, that the threaded bushing can be arranged in such a way that it is protected against contamination and a suitable force can be applied from the retaining device via the guide bushing to the threaded bushing.

According to another embodiment, the threaded bushing can be screwed to the knife bar via an external thread. This has the additional advantage that the threaded bushing ensures reliable force transmission into the knife bar. Furthermore, it is possible to dismantle or replace the threaded bushing without increased assembly effort. In addition, the thread can be used to change the absolute position of the threaded bushing relative to the knife bar. This can be advantageous, for example, after a cutting knife change for precise adjustment of the mower knife device.

According to a further advantageous embodiment, the tension spring can be tensioned by means of a spring screw. This has the technical advantage, for example, that the tension and thus the tensile force of the spring can be adjusted. In particular, the tension can be increased or reduced as required by actuating the spring screw. For example, this can be advantageous after changing the mower knives to ensure the optimum setting of the mower knife device. In addition, it is possible to vary the tension of the tension spring and thus the contact force of the upper cutting knife on the lower cutting knife for a specific application.

In order to change the contact pressure of the upper cutting knife on the lower cutting knife, the spring screw is designed to be adjustable from the outside via a bushing cover. The bushing cover is particularly easy to operate. A special tool is not absolutely necessary. For example, the bushing cover can be actuated manually or by means of a simple commercially available tool. In particular, a screwdriver, a hexagon socket screw key, a ring wrench or an open-end wrench are suitable for this purpose.

According to an additional embodiment, the upper cutting knife including the blade elements and the knife back is designed as a one-piece blade, in particular made of a flat steel. The flat steel design is particularly inexpensive to manufacture. In addition, the flat steel design results in weight savings, which in turn reduce wear and thus have a positive effect on the service life of the mower knife device. In addition or alternatively, the lower cutting knife including the blade elements and the knife back can also be designed as a one-piece blade, in particular made of a flat steel.

A particular advantage results from the reduction of the thickness of the upper cutting knife and the lower cutting knife, which are associated with the one-piece design of the blade. The reduced thickness of the cutting knives improves the sliding of cuttings during operation of the mower knife device, as all edges caused by material thickening of the knife back, as caused by riveted or welded-on blade elements, are eliminated.

According to a further embodiment, each blade element comprises two V-shaped cutting edges, whereby the cutting edge of a first blade element and the opposite cutting edge of an adjacent blade element extend continuously over the knife back. In other words, the cutting edges are continuous and there are no longer any dead edges. This significantly increases the efficiency of the mower knife device. In particular, this embodiment is advantageous in connection with the embodiment according to which the blade elements and the knife back are formed as a one-piece blade, in particular made of a flat steel. Due to the particularly flat design of the one-piece blade, the continuously formed cutting edges can be completely ground and sharpened particularly easily.

Usually, a plurality of cutting knives are arranged serially along the knife bar, with a lower cutting knife usually being associated with each upper cutting knife. According to a particular embodiment, a plurality of upper cutting knives and lower cutting knives are arranged along the knife bar, with an upper retaining device being assigned to every third upper cutting knife. This achieves, for example, the technical advantage of ensuring a continuous distribution of force to all cutting knives along the knife bar. This reduces wear and additionally increases the service life of the device according to the invention.

A third solution to the task is described below. The third solution can be considered as a separate invention, which exists independently of the other solutions of the task.

The third solution concerns a mower knife device with a dual knife cutting system, wherein the dual knife cutting system comprises an upper cutting knife and a lower cutting knife, which are designed to be movable relative to each other by means of a unilateral drive. The mower knife device comprises a knife bar, which is connected to the upper cutting knife by means of an upper retaining device and to the lower cutting knife by means of a lower retaining device. The knife bar comprises a first guide means for guiding the lower cutting knife during a movement by the unilateral drive relative to the knife bar, the first guide means being transferable between an operating position for guiding the lower cutting knife during a movement by the unilateral drive relative to the knife bar and a release position for releasing the lower cutting knife.

This achieves, for example, the technical advantage that the lower cutting knife can be changed quickly. In other words, only the first guide means has to be transferred from the operating position to the release position, and the lower cutting knife can be disassembled in a short time and without great effort. As a result, the overall operating time of the mower knife device can be increased.

According to a preferred embodiment, the transfer of the first guide means between the operating position and the release position takes place by pivoting. This has the technical advantage, for example, that the transfer can be carried out manually and in a simple manner.

According to an additional embodiment, the pivoting of the first guide means between the operating position and the release position takes place in a plane which is arranged parallel to a plane of movement of the upper and lower cutting knives which can move relative to each other.

To prevent unintentional release of the lower cutting knife, the first guide means has a fixing device for fixing the first guide means in the operating position. For example, the fixing device is designed as a manually operable screw. Preferably, the screw has a flat head to ensure the flat design of the dual knife cutting system. During operation of the cutting knife device, high accelerations and strong impacts sometimes occur. Thus, the fixing device fulfills a safety aspect, since the fixing device realizes a safe function of the mower knife device despite the large accelerations and impacts.

According to a particularly preferred embodiment, the lower cutting knife comprises a sliding projection for slidable engaging in the first guide means. This achieves, for example, the technical advantage of ensuring simple guidance of the lower cutting knife. In other words, the fixing device has a multiple function. On the one hand, the fixing device secures the lower cutting knife in operation. On the other hand, the fixing device in interaction with the sliding projection enables a guided movement of the lower cutting knife independent of accelerations and shocks occurring during operation of the mower knife device. Additionally, the fixing means can be moved to the release position, allowing the lower cutting knife to be disassembled. For example, the guide means is at least partially made of plastic, which results in less friction between the sliding protrusion and the guide means.

According to a particularly preferred embodiment, the lower cutting knife has a replaceable lower knife head for initiating a drive movement of a lateral drive on the lower cutting knife, wherein the sliding projection is arranged on the lower knife head. This results, for example, in the technical advantage that the knife head can be completely removed for the purpose of replacing the lower cutting knife. This simplifies the work involved in replacing the lower cutting knife. A particular advantage arises again when grinding the blade elements. Complete removal of the knife head makes it easier to access the blade elements for grinding and sharpening. This increases the service life and improves repair and handling. Furthermore, this results in cost savings. The fact that the sliding protrusion is located directly on the lower knife head means that the number of components and thus the complexity can be reduced.

In order to increase the service life of the mower knife device and reduce wear, the lower knife head has an elastic section formed between the sliding projection and a connection to the drive.

During operation of the mower knife device, the cutting knives are subjected to strong mechanical loads such as impacts or deformations, for example due to stones or other objects. A stiff, inflexible knife head as the connection between the cutting knife and the laterally attached drive places at least mechanical stress on all components of the functional chain. This additionally increases the wear of the entire mower knife device and significantly shortens its service life. The elastic section of the lower knife head can in particular dampen vibrations and deformations, thus relieving the load on the mower knife device. The elastic section thus increases the service life.

According to a particularly preferred embodiment, the elastic section is made of a metal. Metal has a suitable strength and at the same time can have the necessary elasticity. For example, the elastic section is made of a spring steel. Alternatively, however, it is equally conceivable to manufacture the elastic section from a plastic or another suitable material.

According to a particularly preferred embodiment, the elastic section is designed to dampen movement in a plane that is parallel to the plane defined by the blade elements of the upper cutting knife or the lower cutting knife.

According to a further embodiment, the knife bar has a second guide means for guiding the upper cutting knife during a movement by the unilateral drive relative to the knife bar, the second guide means being designed to be transferable between an operating position for guiding the upper cutting knife during a movement by the unilateral drive relative to the knife bar and a release position for releasing the upper cutting knife. This achieves, for example, the technical advantage that the upper cutting knife has a simple additional guide. On the one hand, the second guide means enables a guided movement of the upper cutting knife independent of accelerations and impacts occurring during operation of the mower knife device. On the other hand, the fixing means can be transferred to the release position, allowing the upper cutting knife to be easily disassembled.

To make transfer to the release position particularly easy, the second guide means is transferred between the operating position and the release position with a translational movement. For example, the second guide means is designed to simultaneously guide the lower cutting knife.

According to another particularly preferred embodiment, the second guide means is designed to guide the lower cutting knife during a movement by the unilateral drive relative to the knife bar. For this purpose, the second guide means engages via a guide arm between the upper cutting knife and the knife bar. Thus, the additional advantage is achieved that with the transfer of the second guide means from the operating position to the release position, the upper and the lower cutting knife are released simultaneously.

A fourth solution to the object of the invention is described below. The fourth solution can be considered as a separate invention, existing independently from the other solutions to the object of the invention.

The fourth solution relates to a mower knife device with a dual blade cutting system, wherein the dual blade cutting system comprises an upper cutting knife and a lower cutting knife which are designed to be movable relative to each other by means of a unilateral drive. The upper cutting knife and the lower cutting knife each include a plurality of blade elements, and each blade element includes cutting edges disposed away from each other. The cutting edges of each blade element are concave at least in sections, starting from a knife back in the direction of a cutting knife tip.

For example, this achieves the technical advantage that the at least partially concave design of the cutting edges makes it easier to introduce the material to be cut between the blade elements of the upper and lower cutting knives. A particular advantage results in the subsequent phase, in which the introduced material to be cut is separated due to the closing blade elements. Due to the concave design of the blade elements, the cutting edges at the cutting knife tips run almost parallel to each other. This additionally increases the cutting efficiency because clippings can no longer escape to the front. This effect can be seen, for example, in the example of a classic pair of scissors. When the two cutting edges are fully open, clippings are slightly displaced in the direction of the cutting knife tips of the pair of scissors. This is due in particular to the wide-open angle of the cutting edges, because clippings are not clamped and cut between the cutting edges but are displaced in the direction of the cutting knife tips due to the closing cutting edges. Due to the concave design of the cutting edges, clippings are clamped and cut earlier, which increases the overall cutting efficiency.

According to a preferred embodiment, the concave cutting edges are parallel to each other in the area of the cutting knife tip. This achieves, for example, the technical advantage that the cutting efficiency is additionally increased. Similar effects as in the preceding embodiment come into play, whereby the clippings no longer escape at all due to the parallel section at the cutting knife tips and the clippings can thus be completely cut.

According to a further embodiment, the blade elements are connected to each other via the knife back. Due to the connection of the blade elements via the knife back, the exchangeability of the upper cutting knife and the lower cutting knife is significantly simplified. For example, the blade elements and the knife back are formed in one piece. The one-piece design significantly reduces the mass and thickness of the upper cutting knife and the lower cutting knife. In this regard, the reduced mass allows for a reduction in wear, thereby increasing the service life of the mower knife device. The reduced thickness of the upper cutting knife and the lower cutting knife improves the sliding of clippings during operation of the mower knife device. All edges caused by material thickening of the back of the blade, as caused by riveted or welded-on blade elements, are eliminated.

According to a particularly preferred embodiment, the cutting edge of a first blade element and the opposite cutting edge of an adjacent blade element extend continuously over the knife back. This achieves the advantage, for example, that the cutting edges are continuous and there are no longer any dead edges. This significantly increases the efficiency of the mower knife device. In particular, this embodiment is advantageous in connection with an embodiment according to which the blade elements and the knife back are formed as a one-piece blade, in particular made of a flat steel. Due to the particularly flat design of the one-piece blade, the continuously formed cutting edges can be completely ground and sharpened particularly easily.

According to a particular embodiment, the section of the cutting edge extending continuously over the knife back is designed parallel to a longitudinal axis of the knife back. This achieves, for example, the technical advantage that the cutting efficiency is additionally improved. Overall, more material can be cut between the blade elements of the upper and lower cutting knives.

According to a particularly advantageous embodiment, the concave cutting edges of each blade element, which are arranged facing away from each other, intersect with the section of the cutting edge extending continuously over the back of the blade parallel to the longitudinal axis at an angle α greater than 90° and less than 135°. This results in a particularly functional constellation which, on the one hand, enables a large amount of clippings to be accommodated between the blade elements of the upper and lower cutting knives. On the other hand, the cutting efficiency is increased due to the concave design of the cutting edges.

According to another particularly advantageous embodiment, the angle α is greater than 100° and less than 130°. This additionally increases the cutting efficiency.

A particularly high degree of cutting efficiency results from an improved embodiment according to which the angle α is greater than 110° and less than 120°.

According to a particularly advantageous design, the blade elements and the knife back are formed as a common integral component. This has the further advantage that the integral one-piece design of the blade elements improves the grinding and sharpening of the individual blade elements. Material thickening of the knife back, as caused by riveted or welded-on blade elements, makes it more difficult to access the blade elements for regular grinding and sharpening. This simplifies maintenance and improves handling.

According to a further embodiment, the mower knife device has a replaceable knife head for initiating a drive movement of a lateral drive on the dual knife cutting system. This results, for example, in the technical advantage that the knife head can be completely removed for the purpose of replacing the upper cutting knife or the lower cutting knife. This simplifies the work involved in changing the cutting knives. A particular advantage arises again when grinding the blade elements. Complete removal of the knife head makes it easier to access the blade elements for grinding and sharpening. This increases the service life and improves repair and handling. Furthermore, this results in cost savings.

In order to increase the service life of the mower knife device and reduce wear, the knife head has a resilient portion formed between a connecting portion of the knife head with the knife back and a connection to the drive.

During operation of the mower knife device, the cutting knives are subjected to strong mechanical loads such as impacts or deformations, for example due to stones or other objects. A stiff, inflexible knife head as the connection between the cutting knife and the laterally attached drive places at least mechanical stress on all components of the functional chain. This additionally increases the wear of the entire mower knife device and significantly shortens its service life. The elastic section of the knife head can in particular dampen vibrations and deformations, thus relieving the load on the mower knife device. The elastic section thus increases the service life.

According to a particularly preferred embodiment, the elastic section is made of a metal. Metal has a suitable strength and at the same time can have the necessary elasticity. For example, the elastic section is made of a spring steel. Alternatively, however, it is equally conceivable to manufacture the elastic section from a plastic or another suitable material.

According to a particularly preferred embodiment, the elastic section is designed to dampen a movement in a plane that is parallel to the plane defined by the blade elements of the upper cutting knife or the lower cutting knife. This achieves, for example, the technical advantage that mechanical influences, such as impacts or vibrations, which act on the cutting knives from a front side during operation can be reduced and damped.

A fifth solution to the object of the invention is described below. The fifth solution can be considered as a separate invention that exists independently from the other solutions to the object of the invention.

The fifth solution relates to a mower knife device with a dual blade cutting system, wherein the dual blade cutting system comprises an upper cutting knife and a lower cutting knife. The upper cutting knife and the lower cutting knife are configured to be movable relative to each other by means of a unilateral drive. At least one of the upper cutting knife and the lower cutting knife comprises a plurality of blade elements, which are interconnected by a knife back. The mower knife device has an exchangeable blade head for initiating a drive movement of a lateral drive onto the upper cutting knife, wherein a spring element is assigned to the blade head in order to dampen a relative movement between a drive and the knife head.

This has the technical advantage, for example, of damping a significant portion of the vibrations applied to the upper cutting knife by the drive. Such drives usually comprise eccentrics, which generate movements and vibrations in the cutting knives that are aligned perpendicular to the cutting knife plane. For example, this negatively affects the exact interaction of the upper cutting knife and the lower cutting knife, which in turn promotes wear and thus shortens the service life of the mower knife device.

Another advantage results from simplified disassembly and repair of a cutting knife. Due to the spring element, the connection of the drive must be adjusted less precisely to the cutting knife. In other words, the spring element can compensate for inaccuracies of the drive, resulting in a significant increase in efficiency and reduction in effort when changing a cutting knife. As a result, assembly times are reduced and the standing time of a cutting knife device is minimized.

According to a preferred embodiment, the spring element is arranged between the knife head and the upper cutting knife. This has the technical advantage, for example, that a clamping force applied by the drive to the knife head is transmitted directly to the upper cutting knife. Another advantage is that the spring element can be attached directly to the upper cutting knife.

According to a further embodiment, the spring element is designed to dampen a movement in a plane that is orthogonal to the plane defined by the blade elements of the upper cutting knife or the lower cutting knife. This has the advantage, for example, that the wear of the mower knife device can be additionally reduced and the service life increased.

This applies in particular in connection with an embodiment which has a knife head with an elastic section formed between a connecting section of the knife head with the cutter back and a connection to the drive. During operation of the mower knife device, it happens, for example due to stones or other objects, that the cutting knives are exposed to strong mechanical loads such as impacts or deformations. A stiff inflexible knife head as the connection between the cutting knives and the laterally connected drive places at least mechanical stress on all components of the operating chain. This additionally increases the wear of the entire mower knife device and significantly shortens its service life.

In particular, the elastic section of the knife head can dampen vibrations and deformations, thus relieving the load on the mower knife device. Thus, the elastic section increases the service life. The identical advantages also apply in connection with the spring element for damping a movement formed in a plane which is orthogonal to the plane defined by the blade elements of the upper cutting knife or the lower cutting knife. Thus, movements in two mutually orthogonal planes can be damped, which additionally reduces the wear of the entire mower knife device and significantly increases its service life.

According to a particularly preferred embodiment, the spring element has a leaf spring. This achieves, for example, the technical advantage that leaf springs have low costs and a long service life.

In order to increase the service life of the mower knife device and reduce wear, the knife head has an elastic section which is formed between a connecting section of the knife head with the knife back and a connection to the drive. This has the technical advantage, for example, that the elastic section of the knife head can dampen vibrations and deformations in particular, thereby reducing the load on the mower knife device.

This applies in particular in connection with an embodiment in which the spring element is designed to dampen movement in a plane which is orthogonal to the plane defined by the blade elements of the upper cutting knife or the lower cutting knife. Thus, movements in two mutually orthogonal planes can be damped, thereby reducing the wear of the entire mower knife device and significantly increasing its service life.

According to a particularly preferred embodiment, the elastic section is designed to dampen a movement in a plane that is parallel to the plane defined by the blade elements of the upper cutting knife or the lower cutting knife. This achieves, for example, the technical advantage that mechanical influences, such as impacts or vibrations, which act on the cutting knives from a front side during operation can be reduced and damped.

According to a particularly preferred embodiment, the elastic section is made of a metal. Metal has a suitable strength and at the same time can have the necessary elasticity. For example, the elastic section is made of a spring steel. Alternatively, however, it is equally conceivable to manufacture the elastic section from a plastic or another suitable material.

According to a further preferred embodiment, the upper cutting knife is connected to a knife bar by means of an upper retaining device, the upper retaining device being mounted on the knife bar by means of a guide bushing, and a preloaded tension spring being arranged inside the guide bushing to exert a contact force of the upper cutting knife on the lower cutting knife. This has the technical advantage, for example, that the tension spring is subjected exclusively to tensile stress. As a result, the contact pressure of the upper cutting knife on the lower cutting knife is not generated by a tilting movement of the retaining device, but is transmitted by a purely tensile movement of the retaining device, the effective direction of the contact pressure being parallel to the longitudinal direction of the guide bushing. This significantly reduces wear on the cutting knives, as the contact force is evenly distributed. In addition, this has the advantage that it is possible to change the cutting knife with less effort, since disassembly of the retaining device generates only little effort.

Another significant advantage of the device according to the invention caused by the mechanical load on the mower knives during operation. Often, the upper cutting knife is pushed upwards by stones or severely deformed by impurities between the upper cutting knife and the lower cutting knife. These deformations put additional stress on the cutting knives and increase wear. Due to the spring mounted in the guide bushing, the retaining device can yield to the contact force in the opposite direction, whereby the impurities are removed autonomously and cannot cause permanent wear on the cutting knives. This extends the service life of the mower knife device, as wear is additionally reduced.

According to a preferred embodiment, the guide bushing is held in a threaded bushing. This has the technical advantage, for example, that the guide bushing can be arranged in such a way that it is protected against contamination and a suitable force can be transmitted from the retaining device via the guide bushing to the threaded bushing.

According to another embodiment, the threaded bushing can be screwed to the knife bar via an external thread. This has the additional advantage that the threaded bushing ensures reliable force transmission into the knife bar. Furthermore, it is possible to dismantle or replace the threaded bushing without increased assembly effort. In addition, the thread can be used to change the absolute position of the threaded bushing relative to the knife bar. This can be advantageous, for example, after a cutting knife change for precise adjustment of the mower knife device.

According to a further advantageous embodiment, the tension spring can be tensioned by means of a spring screw. This has the technical advantage, for example, that the tension and thus the tensile force of the spring can be adjusted. In particular, the tension can be increased or reduced as required by actuating the spring screw. For example, this can be advantageous after changing the cutting knives to ensure the optimum setting of the mower knife device. In addition, it is possible to vary the tension of the tension spring and thus the contact force of the upper cutting knife on the lower cutting knife for a specific application.

In order to change the contact pressure of the upper cutting knife on the lower cutting knife, the spring screw is designed to be adjustable from the outside via a bushing cover. The bushing cover is particularly easy to operate. A special tool is not absolutely necessary. For example, the bushing cover can be actuated manually or by means of a simple commercially available tool. In particular, a screwdriver, a hexagon socket screw key, a ring wrench or an open-end wrench are suitable for this purpose.

According to an additional embodiment, the upper cutting knife including the blade elements and the knife back is designed as a one-piece blade, in particular made of a flat steel. The flat steel design is particularly inexpensive to manufacture. In addition, the flat steel design results in weight savings, which in turn reduce wear and thus have a positive effect on the service life of the mower knife device. In addition or alternatively, the lower cutting knife including the blade elements and the knife back can also be designed as a one-piece blade, in particular made of a flat steel.

Usually, a plurality of cutting knives are arranged serially along the knife bar, with a lower cutting knife usually being associated with each upper cutting knife. According to a particular embodiment, a plurality of upper cutting knives and lower cutting knives are arranged along the knife bar, with an upper retaining device being associated with every third upper blade element of the upper cutting knife. This provides, for example, the technical advantage of ensuring a continuous distribution of force to all blade elements along the knife bar. This reduces wear and additionally increases the service life of the device according to the invention.

A sixth solution to the object of the invention is described below. The sixth solution can be considered as a separate invention, existing independently from the other solutions to the object of the invention.

The sixth solution relates to a mower knife device with a substantially horizontally arranged knife bar with at least one cutting knife, which can be set into a reciprocating movement via a drive, and two running shoes, which are arranged in the longitudinal direction of the knife bar in the region of its ends. Each running shoe has a swath wheel which is arranged essentially in the vertical direction and is designed to be rotatable.

The mower knife device is also referred to as a mowing unit and preferably has further elements, such as a connecting arm, with which the mower knife device is connected to a vehicle or can be connected to it. Such a connection is preferably designed to be detachable. In particular, the mower knife device is designed in such a way that this can be connected to a three-point linkage of a tractor. However, the mower knife device can also be designed as a fixed component of a vehicle.

The mower knife device can be used for mowing different clippings, especially for grasses and cereals.

By the horizontal arrangement of the knife bar, which is also referred to as the mower bar, it is understood in the present application that the knife bar or its longitudinal axis is aligned substantially parallel to the ground on which the mower knife device or a vehicle of which the mower knife device is a component or to which the mower knife device is connected stands. Accordingly, the at least one cutting knife or also referred to as the knife rail is also arranged in the horizontal direction.

Preferably, the knife bar is attached or connectable to a vehicle in such a way that the longitudinal axis of the knife bar lies at a right angle to the direction of travel of the vehicle. The direction of travel of the vehicle thus determines the direction of mowing, which is determined in the direction of forward or reverse travel of the vehicle. Preferably, the direction of mowing corresponds to the direction of forward travel of the vehicle.

The vehicle is preferably an agricultural vehicle, in particular a tractor, an implement carrier or a motorized single-axle vehicle.

The mower knife device comprises a dual knife cutting system, wherein the dual knife cutting system comprises an upper cutting knife and a lower cutting knife, which are designed to be movable relative to each other by means of a unilateral drive.

Each cutting knife preferably comprises a plurality of substantially triangular blade elements projecting in the direction of mowing from the cutting knife and the knife bar. The knife bar further comprises a stationary counter-blade or a second cutting knife. The reciprocating motion caused by the drive allows the blade elements to mow the clippings between the at least one upper cutting knife and the counter blade or the lower cutting knife. The upper cutting knife therefore defines the cutting plane of the mowing blade device. This cutting plane is preferably adjustable in the vertical direction by means of adjustment means, whereby the height at which the clippings are mowed can be adjusted. This can preferably be realized by a lifting device with which the mower knife device can be moved in vertical direction relative to the vehicle.

The knife bar preferably comprises fastening means to which the at least one cutting knife can be fastened, in particular releasably. The fastening is designed in such a way that the at least one cutting knife is mounted so as to be linearly displaceable in the longitudinal direction of the knife bar so that it can be moved back and forth relative to the knife bar.

Preferably, the at least one cutting knife has the same length as the knife bar. Alternatively, however, the at least one cutting knife can also be longer than the knife bar, i.e. the at least one cutting knife can project beyond the knife bar on both sides.

The running shoes are preferably arranged at one end each in the longitudinal direction of the knife bar. Alternatively, however, the running shoes can also be arranged at a distance from the ends of the knife bar. However, this distance should be as small as possible, in particular no greater than 5% of the length of the knife bar.

The guide plate preferably extends from the cutting plane in the vertical direction to beyond the knife bar. Preferably, the guide plate extends in the vertical direction as far as the cutting plane. The guide plate extends in front of the knife bar in the mowing direction. As a result, each guide plate can divide the material to be cut in the area of the ends of the knife bar in the direction of mowing, so that clippings provided in front of the knife bar relative to the direction of mowing is directed towards the knife bar, while material not in front of the knife bar relative to the direction of mowing is directed away from it.

The swath wheel is also referred to as a grass dividing disc, for example. This has the technical advantage, for example, that the rotation of the swath wheel allows stalks of the clippings to be aligned parallel to the direction of mowing, which leads to better cutting results. The swath wheel is preferably designed as a disc, which is connected to the running shoe via a roller bearing.

According to a preferred embodiment, at least one swath wheel is arranged on the running shoe in such a way that a lower apex of the swath wheel lies in the vertical direction below the cutting plane of the at least one cutting knife. The swath wheel is preferably arranged such that the swath wheel comes into contact with the ground at the lower apex, so that the swath wheel is passively rotated by the movement of the mower in the mowing direction. The direction of rotation of the swath wheel at the lower apex is thus opposite to the mowing direction.

Alternatively, the swath wheel can be set in rotary motion via a drive, in particular in such a way that the swath wheel has a direction of rotation at its lower apex that is opposite to the direction of mowing.

According to a further embodiment, the swath wheel has a toothing on the circumference, each tooth having an arcuately rising long shoulder and an essentially right-angled falling shoulder, the swath wheel being arranged on the running shoe in such a way that at the lower apex of rotation the short shoulder points in the direction of rotation.

According to a particularly preferred embodiment, the swath wheel is designed to be adjustable in a vertical direction.

This provides the technical advantage, for example, that the swath wheel can adapt to the conditions of the soil. This can additionally improve the alignment of the clippings parallel to the direction of mowing, which leads to better cutting results.

Based on this, the adjustability in the vertical direction is designed for independent adaptation of the swath wheel to a ground surface during operation of the mower knife device.

According to an advantageous embodiment, the swath wheel is mounted on the running shoe via a pendulum arm. This has the technical advantage, for example, that the vertical movement of the swath wheel is achieved via a mechanically wear-free but simple solution.

According to an additional preferred embodiment, the pendulum arm is designed to be movable between a first stop and a second stop. This achieves, for example, the technical advantage that a vertical movement interval is defined for the swath wheel. The upper stop and the lower stop also allow, for example, the swath wheel to be changed depending on the intended use. In particular, the size of the swath wheel can be changed without having to adjust the upper and lower stops.

According to a further embodiment, the first stop and the second stop define an angular interval of maximum 90°. This achieves, for example, the technical advantage that a specific interval of vertical adjustment can be defined depending on the length of the pendulum arm.

According to an embodiment based on this, the angular interval is aligned from a bearing of the pendulum arm on the running shoe in the direction of the knife bar.

According to a further advantageous embodiment, the first stop is arranged above and the second stop below a plane parallel to the knife bar and passing through the bearing of the pendulum arm on the running shoe.

To reduce the number of components, the first stop and/or the second stop are arranged directly on the running shoe. This has the additional technical advantage that even strong impacts of the swath wheel are transmitted directly into the structure of the running shoe via the pendulum arm. This additionally reduces wear and increases the service life of the mower knife device.

According to a further embodiment, the running shoes each have a guide plate which is arranged essentially in the vertical direction and extends relative to the direction of mowing in front of and partly also behind the knife bar. For example, the guide plate extends in front of the knife bar in the mowing direction. As a result, each guide plate can divide the clippings in the area of the ends of the knife bar relative to the mowing direction, so that clippings in front of the knife bar relative to the mowing direction is directed towards the knife bar, while clippings not in front of the knife bar relative the mowing direction is directed away from it.

According to another embodiment, the guide plates are spaced further apart from each other at the front relative to the direction of mowing than in the area of the ends of the knife bar. This has the technical advantage, for example, that the guide plates form a kind of funnel so that the clippings are guided as efficiently as possible to the knife bar or the at least one cutting knife. In this case, the guide plates of the two running shoes are at an angle relative to the direction of cutting. This angle is preferably less than 45°, in particular less than 20°.

According to a particularly advantageous embodiment, the running shoe is designed to be open at the bottom. In other words, the running shoe has a recess in which in each case one end of the at least one cutting knife can be received, wherein a deflector, which projects in the vertical direction from above at least as far as a cutting plane of the at least one cutting knife, is arranged on the guide plate at a distance from the cutting knife in the mowing direction.

In the area of the recess, no further component of the mower knife device is arranged below the cutting knife, so that there is a free space between the cutting knife and the ground. The deflector can be used to push aside stalks of clippings that are not directly in front of the knife bar or cutting knife in the mowing direction and have not already been deflected away by the deflector plates. Preferably, the deflector extends vertically to below the cutting plane.

### BRIEF DESCRIPTION OF THE SEVERAL VIEWS OF THE DRAWINGS

Further advantages features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

The following is an advantageous embodiment of the invention with reference to the accompanying figures, wherein:

FIG. 1 depicts an upper cutting knife with knife head;

FIG. 2 depicts a dual knife cutting system with drive and upper retaining device;

FIG. 3 depicts a cross-sectional view of an upper cutting knife at the level of an upper retaining device;

FIG. 4 depicts a sectional view of a lower cutting knife at the level of a lower retaining device;

FIG. 5 depicts a schematic representation of an upper cutting knife with knife head;

FIG. 6 depicts a mower knife device according to a further embodiment;

FIG. 7 depicts a top view of the mower knife device according to the embodiment in FIG. 6;

FIG. 8 depicts a partial view of the mower knife device according to the embodiment in FIG. 6;

FIG. 9 depicts a mower knife device according to an additional embodiment;

FIG. 10 depicts another embodiment of a mower knife device;

FIG. 11 depicts an alternative embodiment of a mower knife device according to the embodiment of FIG. 10; and

FIG. 12 depicts an additional embodiment of a mower knife device.

In principle, the same parts are given the same reference signs in the figures.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of” “A, B, and C” should be understood as including not only one of A, only one of B, only one of C, or any combination of A, B, and C.

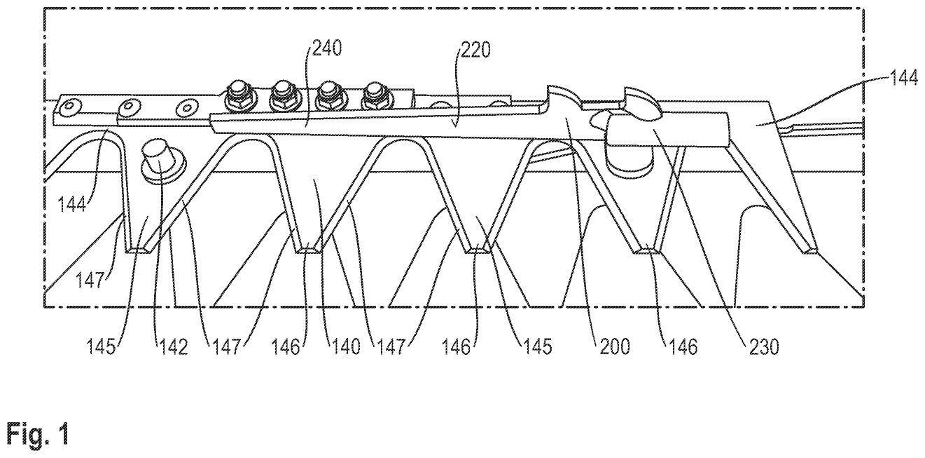

FIG. 1 shows an upper cutting knife 140 with a knife head 200. The upper cutting knife 140 is part of the mower knife device (not shown), which includes a dual blade cutting system (not shown) having the upper cutting knife 140 and a lower cutting knife (not shown). The upper cutting knife 140 and the lower cutting knife 180 are moved relative to each other by means of a drive 114. Both the upper cutting knife 140 and the lower cutting knife 180 each have a plurality of blade elements 145 that are formed to be connected to each other by a knife back 144, 184. Thus, the blade elements 145 and the knife back 144, 184 are formed as a common integral component. For example, they are stamped out of a flat steel, which makes them very inexpensive to manufacture. In addition, the mower knife device 100 includes a replaceable knife head 200 to transmit drive motion from a lateral drive (not shown) to the dual blade cutting system 111. The knife head 200 has a resilient portion 220 formed between a connecting portion 240 of the knife head 200 to the upper cutting knife 140 and a port 230 for connecting to a drive.

The entire knife head 200 with connecting section 240, elastic section 200 and connection 230 is made of one piece. For example, the knife head can also be made of a flat steel, whereby the elastic section 220 is also made of metal. In particular, the elastic section 220 can realize a damping function in a plane formed parallel to the plane defined by the blade elements 145 of the upper cutting knife 140.

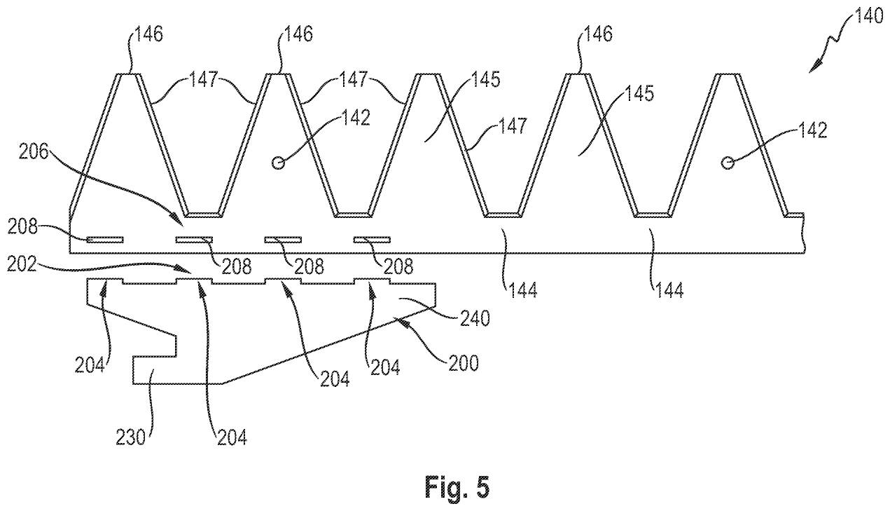

In the illustrated embodiment, the connecting section 240 is fixed to the upper cutting knife 140 by means of screws and rivets. In addition, the connecting portion 240 of the knife head 200 includes an engaging member (not shown) provided for engaging with a corresponding engaging socket (not shown) in the knife back 144 of the upper cutting knife (140). This will be discussed in detail in the description of FIG. 5.

As described above, both the upper cutting knife 140 and the lower cutting knife 180 each include a plurality of blade elements 145 connected to each other by the knife back 144, 184 and formed as a common integral component. In this regard, each blade element 145 has two V-shaped cutting edges 147. At a front side of each blade element 145, the cutting edge 147 is interrupted by a flattened cutting knife tip 146.

The cutting edge 147 of a first blade member 145 and the opposite cutting edge 147 of an adjacent blade member 145 extend continuously across the knife back 144, 184, whereby the cutting edge 147 is formed continuously across the knife back 144.

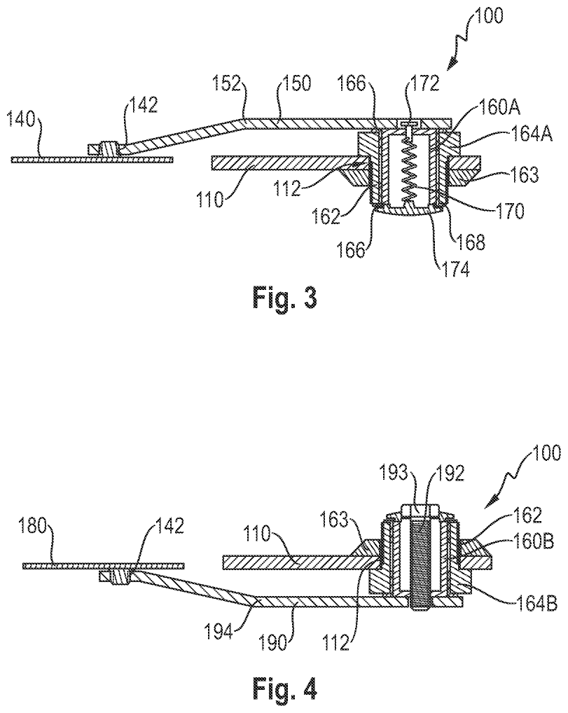

On an upper side of a blade element 145, there is a cutting knife bearing 142 in the form of a pin. The cutting knife bearing 142 serves to connect the upper cutting knife 140 to an upper retaining device 150. The function of the upper retaining device 150 is explained in detail in FIG. 3.

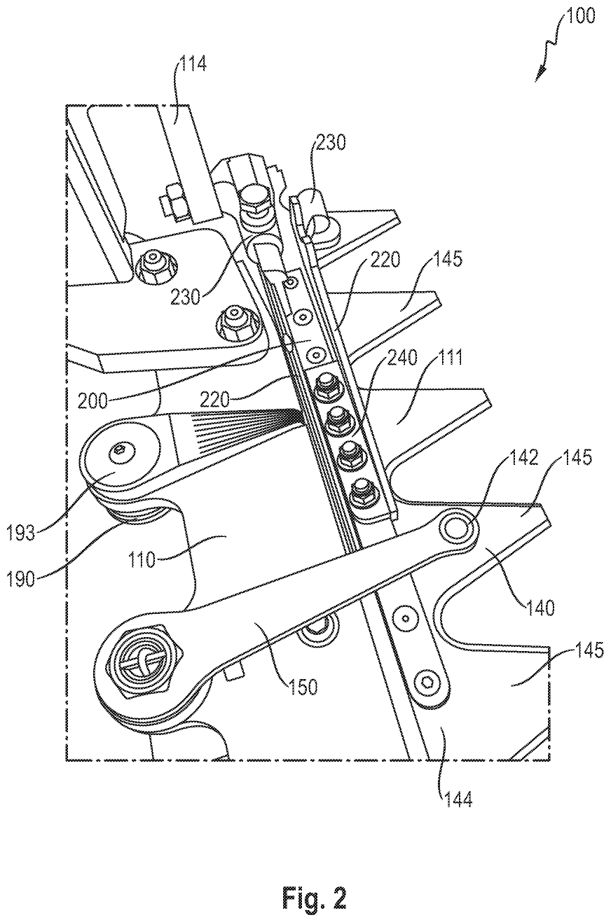

FIG. 2 illustrates a dual knife cutting system 111 having a drive 114 and an upper support device 150. The mower knife device 100 includes a knife bar 110 that supports a dual knife cutting system 111. The dual knife cutting system 111 includes upper cutting knife 140 and lower cutting knife 180 (not shown). In operation, the upper cutting knife 140 and the lower cutting knife 180 are moved relative to each other by means of a drive 114, such as a crankshaft drive formed on one side.

The upper cutting knife 140 is connected to the knife bar 110 by means of an upper retaining device 150. The upper retaining device 150 is mounted on the knife bar 110. A guide bushing (not shown) allows for the necessary movement of the upper retaining device 150 relative to the knife bar 110, which occurs during operation of the mower knife device 100 due to the relative movement of the dual knife cutting system 111.

Adjacent to the upper retainer 150 is a lower retainer 190 having an easily accessible screw head 193, which is connected to a screw 192 (not shown). The screw 192 serves to fix the lower retaining device 190 to the knife bar 110. The lower retaining device 190 connects the lower cutting knife 180 to the knife bar 110.

Both the upper cutting knife 140 and the lower cutting knife 180 are each connected to the drive 114 via a replaceable knife head 200.

Each of the two knife heads 200, that is, the knife head 200 of the upper cutting knife 140 and the knife head 200 of the lower cutting knife 180, has a resilient portion 220 disposed between a connecting portion 240 of the knife head 200 with the cutting knife 140, 180 and a terminal 230 for connection to the drive 114.

FIG. 3 shows a mower knife device 100 according to the invention in a sectional view at the level of the upper retaining device 150 according to an exemplary embodiment. The mower knife device 100 comprises the knife bar 110 and the dual knife cutting system 111, wherein the dual knife cutting system 111 comprises the upper cutting knife 140 and the lower cutting knife 180 (not shown). The upper cutting knife 140 is connected to the knife bar 110 by means of the upper retaining device 150.

The upper retaining device 150 is mounted on the knife bar 110 via a guide bushing 160A. The guide bushing itself is arranged in a threaded bushing 164A, which in turn is designed to be screwed to the knife bar 110 via an external thread 162. To screw the threaded bushing 160A, it is guided through the socket 112 in the knife bar 110. The screw connection of the threaded bushing 164A is additionally secured by a lock nut 163. Within the threaded bushing 164A is a bearing 166, which supports the guide bushing 160A with substantially low friction for both rotational and translational movement relative to the threaded bushing 164A. The bearing 166 is formed on both the upper surface and the lower surface of the threaded bushing 164A, allowing various bearing functions to be implemented. The rotational bearing component, which is generated due to the movement of the upper and lower cutting knives 140, 180 relative to each other, can be accommodated, for example, by the use of an annular roller bearing. The translational motion component stresses the guide bushing 160A in the longitudinal direction, so the arrangement of a plain bearing is advantageous. The ideal bearing is one that can support both the rotational load and the load in the longitudinal direction of the guide bushing. The bearing further reduces wear on the mower knife device 100, thereby increasing the overall life of the mower knife device.

A preloaded tension spring 170 is located within the guide bushing 160A. The tension spring 170 is connected at its first end to the upper retaining device 150 via a spring bolt 172. The tension spring 170 extends through the guide bushing 160A and is connected at its second end to a bushing cover 174. The bushing cover 174 has a radial protrusion 168 relative to the threaded bushing 164A, whereby the tension spring 170 can be placed under tensile stress on the one hand and can be adjusted from the outside via the bushing cover 174 on the other hand.

The tension of the tension spring 170 pulls the upper retaining device 150 to the knife bar 110. The tightening of the upper retaining device 150 to the knife bar 110 causes a contact force of the upper cutting knife 140 on the lower cutting knife 180 (not shown). The guide bushing 160A, via its bearings 166 within the threaded bushing 164A, ensures that the tension spring 170 can be loaded exclusively by tension. As a result, the contact force of the upper cutting knife 140 on the lower cutting knife 180 is not generated by a tilting movement of the upper retaining device 150, but is transmitted by a purely tensile movement of the upper retaining device 150. The effective direction of the contact force on the upper cutting knife 140 thus acts parallel to the longitudinal direction of the guide bushing 160A.

The upper retaining device 150 also has a kinking 152. The kinking 152 is arranged between the guide bushing 160A and the upper cutting knife 140, whereby the contact pressure of the tension spring 170 can be optimally transmitted from the upper cutting knife 140 to the lower cutting knife 180. The kinking 152 thus compensates for the spatial expansion of the tension spring 170, which is arranged orthogonally to the knife bar due to the orientation of the guide bushing 160A. The upper cutting knife 140 is guided in the cutting knife bearing 142 of the upper retaining device 150.

FIG. 4 shows a mower knife device 100 according to the invention in a sectional view at the level of the lower retaining device 190 according to an exemplary embodiment. In contrast to the upper retaining device 150, the lower retaining device 190 is firmly connected to the knife bar 110 without a spring element. This has the particular purpose that the already described contact pressure of the upper cutting knife 140 on the lower cutting knife 180, which is generated by the tension spring 170, can be absorbed.

The lower retaining device 190 is fixed to the knife bar 110 by means of a guide bushing 160B. The guide bushing 160B is located inside a threaded bushing 164B, which is screwed to the knife bar 110 via an external thread 162. To screw the threaded bushing 160B, it is guided through the socket 112 in the knife bar 110. An additional lock nut 163 further secures the screwed-in threaded bushing 164B to the knife bar 110. The threaded bushing 164B can thus be disassembled or replaced without increased assembly effort. In addition, the thread of the threaded bushing 164B can be used to change the absolute position of the threaded bushing 164B relative to the knife bar 110. This enables precise adjustment of the lower retaining device 190 in coordination with the upper retaining device 150.

In addition, the lower retaining device 190 has a screw 192 that extends completely through the guide bushing 164B and fixes the lower retaining device 190 to the knife bar 110. The screw 192 has an easily accessible screw head 193, through which fixing or loosening of the lower retaining device 190 with the knife bar 110 can be easily performed. In addition, by passing the screw 192 through the complete guide bushing 164B, a symmetrical force introduction is realized.

Furthermore, the lower retaining device 190 has a kinking 194. The kinking 194 is arranged between guide bushing 160B and the lower cutting knife 180. The lower cutting knife 180 is guided in a cutting knife bearing 142 of the lower retaining device 190.

FIG. 5 shows a schematic representation of an upper cutting knife 140 with a knife head 200. The upper cutting knife 140 comprises several blade elements 145, which are connected to each other via the knife back 144. The blade elements 145 and the knife back 144 thus form a common integral component which is, for example, punched out of a flat steel. In addition, the replaceable knife head 200 is shown, which transmits the driving motion of a lateral drive (not shown) to the upper cutting knife 140. The knife head 200 has an engaging element 202 configured to engage a corresponding engaging socket 206 in the cutter back 200 of the upper cutting knife 140. The engaging element 202 of the knife head 200 includes a total of four engaging projections 204, which correspond to a total of four engaging openings 208 formed in the knife back 200 of the upper cutting knife.

Each blade element 145 has two cutting edges 147 formed in a V. The cutting edges 147 are interrupted at each cutting knife tip 146, while the cutting edges 147 of two adjacent blade elements 145 extend continuously across the knife back 144. Each third blade element 145 of the upper cutting knife 140 has a cutting knife bearing 142 configured to locate the upper retaining device 150.

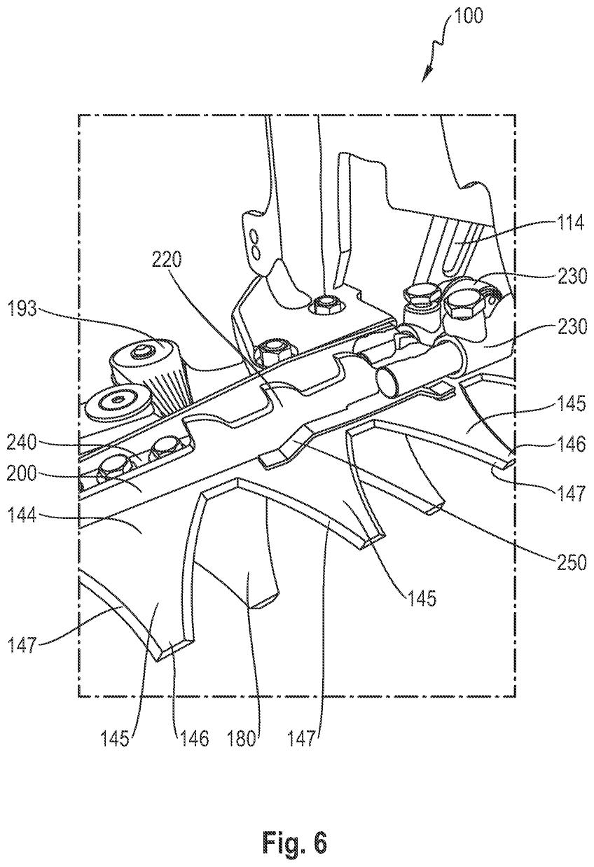

FIG. 6 illustrates a mower knife device 100 according to another embodiment. The mower knife device 100 comprises the dual knife cutting system 111, an upper cutting knife 140 and a lower cutting knife 180. Both the upper cutting knife 140 and the lower cutting knife 180 each have a plurality of blade elements 145. The blade elements 145 each have cutting edges 147 arranged away from each other. The cutting edges 147 of each blade element 145 extend concavely toward each other from the knife back 144, 184 toward the cutting knife tip 146.

The blade elements 145 are connected to each other via the knife back 144, 184, wherein the cutting edge 147 of a first blade element 145 and the opposite cutting edge 147 of an adjacent blade element 145 extend continuously along the knife back 144, 184. In other words, the cutting edge 147 extends continuously along the entire length of the cutting knife 140, 180.

That portion of the cutting edge 147 which extends between two adjacent blade elements 145 extends parallel to the longitudinal axis of the knife back 144, 184. The blade elements 145 and the knife back 144, 184 are formed as a common integral component and are made of hardened flat steel. An angle α is defined by the concave cutting edges 147 directed away from each blade element 145 and the portion of the cutting edge 147 parallel to the longitudinal axis of the knife back 144, 184. The angle α is approximately 130°.

Laterally, the mower knife device 100 includes a replaceable knife head 200 which serves to initiate a driving motion by a lateral drive 114 on the dual knife cutting system 111. Between the connecting portion 240 of the knife head 200 with the knife back 144, 184 and the terminal 230 to the drive 114 is a resilient portion 220 which is made of a metal. The elastic section 220 serves to dampen a movement in a plane formed parallel to the plane defined by the blade elements 145 of the upper cutting knife 140 and the lower cutting knife 180.

The knife head 200 includes a spring element 250 disposed between the knife head 200 and the upper cutting knife 140. The spring element 250 is designed as a leaf spring and serves to dampen a relative movement between the drive 114 and the knife head 200. The spring element 250 primarily dampens movements that take place in a plane that is orthogonal to the plane defined by the blade elements 145 of the upper cutting knife 140 or the lower cutting knife 180.

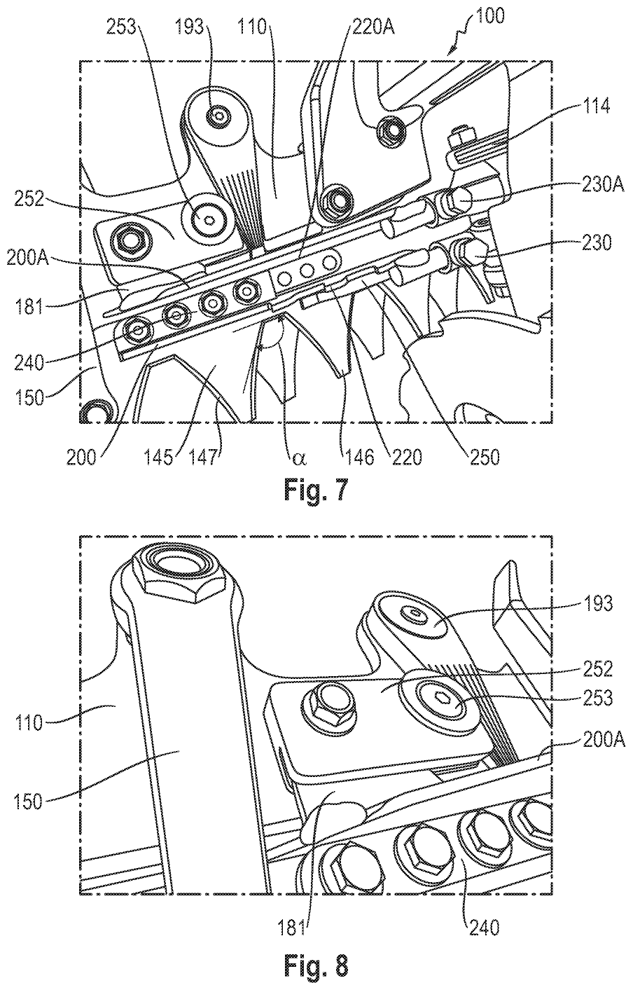

FIG. 7 shows a top view of the mower knife device 100 according to the embodiment in FIG. 6. The mower knife device 100 with the dual blade cutting system 111 comprising the upper cutting knife 140 and the lower cutting knife 180 can be seen.

An upper retaining means 150 for holding the upper cutting knife 140 and a lower retaining means 190 for holding the lower cutting knife 180 are provided on the knife bar 110. Additionally, a first guide means 252 is associated with the knife bar 110 and is mounted directly on the knife bar 110. The first guide means 252 serves to guide the lower cutting knife 180 during a movement by the single-ended drive 114 parallel to the knife bar 110.

The first guide means 252 can be pivoted back and forth between an operating position and a release position. In the release position, the lower cutting knife 180 can be released and removed from the mower knife device 100.

The lower cutting knife 180 has a sliding projection 181, which slidably guides the lower cutting knife 180 into engaging with the first guide means 252 during movement by the single-ended drive 114 parallel to the knife bar 110. The sliding protrusion 181 is arranged directly on the lower knife head 200A.

The first guide means 252 further comprises a fixing device 253 in the form of a screw with an Allen head for fixing the first guide means 252 in the operating position. Thus, the fixing device 253 can be removed and the first guide means 252 can be easily pivoted to the release position. This releases the sliding protrusion 181 on the lower knife head 200A. Between the sliding protrusion 181 and the terminal 230A to the drive 114 is a resilient portion 220A configured to dampen movement in a plane parallel to the plane defined by the blade elements 145 of the upper cutting knife 140 and the lower cutting knife 180.

FIG. 8 shows an enlarged partial view of the mower knife device 100 according to the embodiment according to FIG. 6.

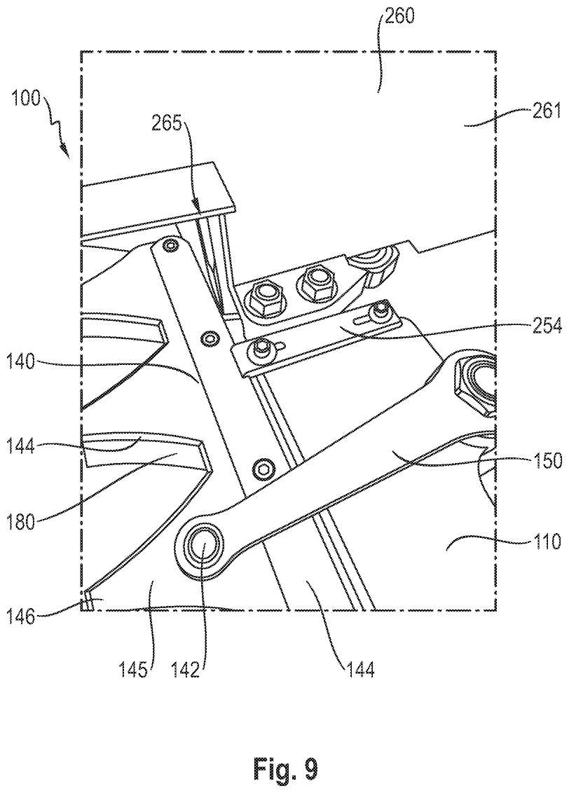

FIG. 9 illustrates the mower knife device 100 according to an additional embodiment. The knife bar 110 has a second guiding means 254. The second guiding means 254 serves to guide the upper cutting knife 140 during movement by the unilateral drive 114 parallel to and relative to the knife bar 110. The second guiding means 254 is designed to be transferable between an operating position for guiding the upper cutting knife 140 and a release position for releasing the upper cutting knife 140. In order to transfer the second guide means 254 into the release position, only two fixing means in the form of hexagon socket screws have to be loosened. Following the loosening of the fixing means, the second guide means 254 can be pushed into the release position. In addition, the second guide means 254 is set up to guide the lower cutting knife 180 (not shown). For this purpose, the second guide means 254 engages between the upper cutting knife 140 and the knife bar 110 via a guide arm (not shown). Thus, the upper cutting knife 140 and the lower cutting knife 180 can be guided and released simultaneously during operation.

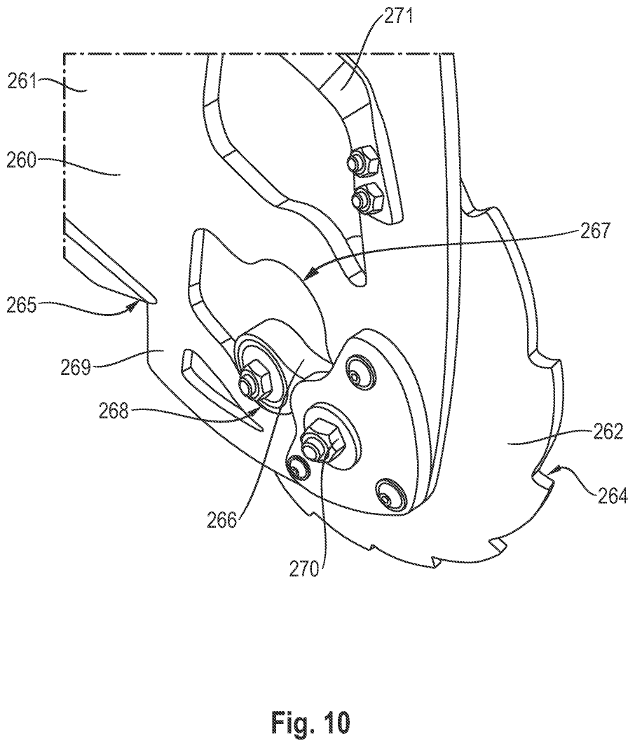

FIG. 10 shows another embodiment of a mower knife device 100. The mower knife device 100 again comprises the substantially horizontally arranged knife bar 110 with the cutting knives 140, 180, which can be set in a reciprocating motion via a drive 114 (not shown). The cutting knife device 100 includes two running shoes 260 arranged in the longitudinal direction of the knife bar 110 in the region of the ends thereof. Each running shoe 260 comprises a swath wheel 262, which is arranged in a substantially vertical direction and is rotatable. The swath wheel 262 is arranged on the running shoe 260 in such a way that a lower vertex of the swath wheel 262 lies in the vertical direction below the cutting plane of the cutting knives 140, 180.

On the circumference of the swath wheel 262 is a toothing 264 with a plurality of teeth, each tooth having an arcuately rising long shoulder and a substantially right-angled falling shoulder. In this regard, the swath wheel 262 is arranged on the running shoe 260 such that at the lower apex of rotation, the short shoulder points in the direction of the mowing. The swath wheel 262 is adjustable in a vertical direction and is designed for independent adaptation to a ground surface during operation of the mower knife device 100. In this regard, the swath wheel 262 is supported on the running shoe 260 via a pendulum arm 266. The running shoe 260 has a first stop 267 and a second stop 268 for specifying an angular interval for the pendulum arm 266 of the swath wheel 262. Within these two stops 267, 268, the pendulum arm 266 is free to move and can independently adjust to a ground surface during operation of the mower knife device 100. FIG. 10 shows the pendulum arm 266 in contact with the second stop 268, causing the swath wheel 262 to assume the lowest possible position.

The running shoe 260 has a recess 265, whereby the running shoe 260 is open at the bottom. The running shoe 260 thus has a recess 265 in which one end of each of the cutting knives 140, 180 is received. A deflector 269 projects downwardly in a vertical direction from above at least as far as the cutting plane of the cutting knives 140, 180, wherein there is a distance from the cutting knives 140, 180 in the mowing direction. In the area of the recess 265, no further component of the mower knife device 100 is arranged below the cutting knives 140, 180, whereby a clearance exists between the cutting knives 140, 180 and the ground.

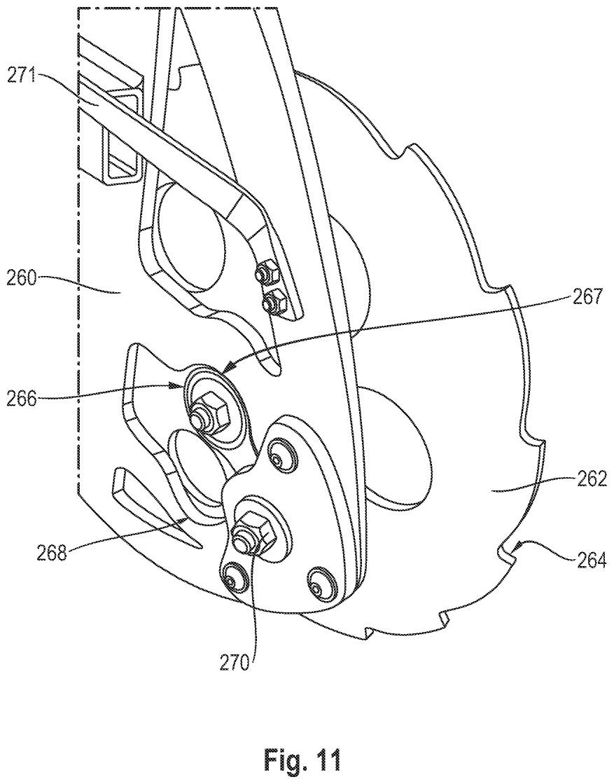

FIG. 11 shows an alternative embodiment of the mower knife device 100 according to the embodiment of FIG. 10. In contrast to FIG. 10, FIG. 11 shows the pendulum arm 266 in contact with the first stop 267, whereby the swath wheel 262 assumes the highest possible position. A repeated description of identical features is omitted here.

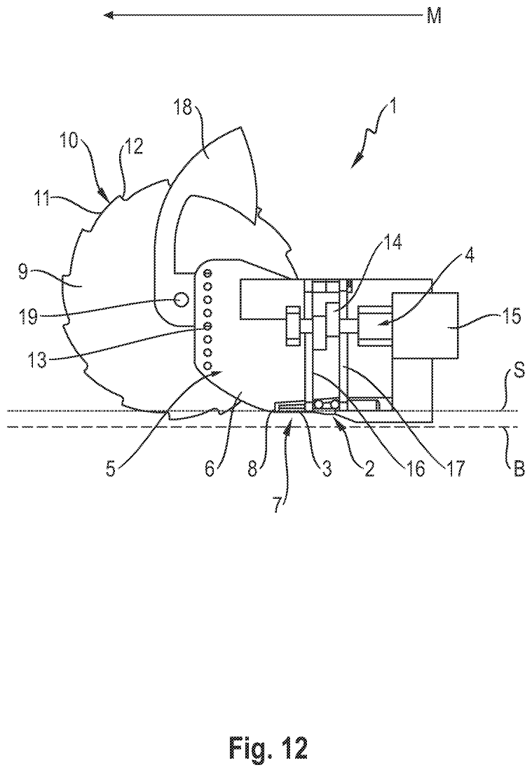

FIG. 12 shows an embodiment of a mower 1 according to the invention from the side. According to the present invention, the mower 1 can also be referred to as a mower knife device 100. The mower 1 has a knife bar 2, the longitudinal axis of which extends in the direction of observation. The knife bar 2 may also be referred to as the knife bar 110. The knife bar 2 extends substantially horizontally, i.e. substantially parallel to a ground B. In the embodiment shown, the knife bar 2 has a dual knife rail 3. The dual knife rail 3 may also be referred to as a dual knife cutting system 111. The dual knife rail 3 has a plurality of knife blades extending away from the dual knife rail 3 in the direction of mowing M, which are arranged in two superimposed knife rails. The two knife rails of the dual knife rail 3 can be moved back and forth relative to each other by a drive 4 in order to mow clippings.

The mower 1 also has two running shoes 5, of which only the left running shoe 5 in the direction of mowing M can be seen in the figure. The running shoe 5 has a guide plate 6, which is located in front of the knife bar 2 or the double knife rail 3 in the direction of mowing M and extends partially above the knife bar 2 and the double knife rail 3. The deflector plate 6 extends essentially in a vertical direction, with the main surface of the deflector plate 6 being essentially parallel to the mowing direction M.

The guide plate 6 comprises a recess 7, in which one end of the dual knife bar 3 can be accommodated, as well as a deflector 8, which extends in vertical direction from the guide plate 6 to at least the cutting plane S of the dual knife bar 3. The deflector 8 is at a distance from the dual knife bar 3 in the direction of cutting. This design means that there is no element between the running shoe 2 and the floor 1 that presses clippings flat.

A swath wheel 9 is also rotatably mounted on the guide plate 6 via a roller bearing 19. The swath wheel 9 is in the form of a disk which is vertically oriented and which has a plurality of teeth 10 on its circumference. Each tooth 10 has an arcuately rising, long shoulder 11 and a substantially right-angled falling short shoulder 12. The swath wheel 9 is arranged on the guide plate 6 in such a way that this projects at a lower vertex below the cutting plane S and the short shoulder 12 of the teeth 10 points in the direction of mowing.

The drive 4 has a crank drive 14, which is driven in rotation by a motor 15. The crank drive 14 is connected to the two knife rails of the dual knife rail 3 via a front oscillating lever 16 and a rear oscillating lever 17, so that these can be moved back and forth.

The mower 1 also has a device 13 for moving the running shoes 2 in the vertical direction. In addition, a guide rod 18 is arranged on the guide plate 6.

The scope of protection of the present invention is given by the claims and is not limited by the features illustrated in the description or shown in the figures.

What is claimed is:

1. A mower knife device comprising:
a knife bar; and
a dual knife cutting system comprising an upper cutting knife and a lower cutting knife arranged to move relative to each other; wherein
the upper cutting knife is connected to the knife bar by means of an upper retaining device;
the lower cutting knife is connected to the knife bar by means of a lower retaining device;
the upper retaining device is mounted on the knife bar by means of a guide bushing;
a preloaded tension spring is arranged inside the guide bushing; and
the tensile force of the tension spring is configured to apply a contact pressure of the upper cutting knife to the lower cutting knife via the upper retaining device.

2. The mower knife device according to claim 1, wherein the guide bushing is configured to be retained in a threaded bushing.

3. The mower knife device according to claim 2, wherein the threaded bushing is configured to be screwed to the knife bar via an external thread.

4. The mower knife device according to claim 1, wherein the guide bushing is configured to be retained in the threaded bushing via a bearing.

5. The mower knife device of claim 4, wherein the bearing is formed on an upper side and a lower side of the threaded bushing.

6. The mower knife device according to claim 1, wherein the tension spring is configured to be tensionable by means of a spring screw.

7. The mower knife device according to claim 6, wherein the spring screw is configured to be adjustable from outside via a bushing cover.

8. The mower knife device according to claim 7, wherein the bushing cover comprises a radial protrusion relative to the threaded bushing.

9. The mower knife device according to claim 1, wherein the upper retaining device comprises a kinking which is arranged between the guide bushing the upper cutting knife (140).

10. The mower knife device according to claim 1, wherein the upper cutting knife is configured to be guided in a cutting knife bearing of the upper retaining device.

11. The mower knife device according to claim 1, wherein the lower retaining device is mounted on the knife bar by means of a guide bushing.

12. The mower knife device according to claim 11, wherein the guide bushing is arranged to be retained in a threaded bushing.

13. The mower knife device according to claim 12, wherein the threaded bushing is configured to be screwed to the knife bar via an external thread.

14. The mower knife device according to claim 11, wherein:
the lower retaining device is configured to be screwable to the knife bar by means of a screw; and
the screw is arranged to extend completely through the guide bushing.

15. The mower knife device according to claim 1, wherein:
the upper cutting knife comprises a plurality of blade elements; and
an upper retaining device associated with each third blade element.
